(19) United States
(12) Patent Application Publication
(10) Pub. No.: US 2025/0328572 A1
(43) Pub. Date: Oct. 23, 2025

(54) METHOD FOR ESTABLISHING DATABASE AND INFORMATION RETRIEVAL AND RELATED DEVICES

(71) Applicant: Lenovo (Beijing) Limited, Beijing (CN)

(72) Inventors: Qiushi HAN, Beijing (CN); Cong LI, Beijing (CN); Jia ZHAO, Beijing (CN)

(21) Appl. No.: 19/178,530

(22) Filed: Apr. 14, 2025

(30) Foreign Application Priority Data
Apr. 17, 2024 (CN) 202410466039.6

(51) Int. Cl. G06F 16/35; G06F 16/338; G06F 16/34

(52) U.S. Cl. CPC G06F 16/35; G06F 16/338; G06F 16/345

(57) ABSTRACT

A method for establishing a database including obtaining a document; performing clustering and summarizing processing on original sentences of the document for at least one round by using a large model to obtain summary sentences for each round; determining the summary sentence of each round as a second information set corresponding to the document; and constructing a target database based on a first information set and the second information set corresponding to the document. The first information set includes at least one original sentence corresponding to the document, and the target database includes the first information set and the second information set corresponding to a plurality of documents respectively.

### CROSS-REFERENCES TO RELATED APPLICATION

This application claims priority to Chinese Patent Application No. 202410466039.6 filed on Apr. 17, 2024, the entire content of which is incorporated herein by reference.

### FIELD OF TECHNOLOGY

The present disclosure relates to the field of information processing

technology and, more specifically, to a method for establishing a database, an information retrieval method and related devices.

### BACKGROUND

In the field of information retrieval, the information database contains a lot of information, and there is a lot of interference information in the retrieval process, which makes the final retrieval results less accurate.

### SUMMARY

One aspect of present disclosure provides a method for establishing a database. The method for establishing a database includes obtaining a document; performing clustering and summarizing processing on original sentences of the document for at least one round by using a large model to obtain summary sentences for each round; determining the summary sentence of each round as a second information set corresponding to the document; constructing a target database based on a first information set and the second information set corresponding to the document. The first information set includes at least one original sentence corresponding to the document, and the target database includes the first information set and the second information set corresponding to a plurality of documents respectively.

Another aspect of present disclosure provides an information retrieval method. The information retrieval method includes in response to receiving to-be-retrieved input information, determining a first information set and a second information set corresponding to each document from a target database; determining a first matching value between the input information and a first target document corresponding to the first information set, and a second matching value between the input information and a second target document corresponding to the second information set; determining at least one third target document corresponding to the input information based on the first matching value and the second matching value. The first information set includes one original sentence corresponding to the document, and the second information set includes a summary sentence obtained by at least one round of clustering summarizing processing on the original sentence corresponding to the document. The first target document is the same as or different from the second target document, and the third target document belongs to the first target document or the second target document.

Another aspect of the present disclosure provides a device for establishing a database comprising one or more processors and computer program instructions stored in computer readable storage medium, when executed by the one or more processors, the computer instructions implementing a method for establishing the database described herewith.

Another aspect of the present disclosure provides A device for establishing a database comprising one or more processors and computer program instructions stored in computer readable storage medium, when executed by the one or more processors, the computer instructions implementing a method for retrieving information described herewith.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a method for establishing a database according to some embodiments of the present disclosure.

FIG. 2 is a schematic diagram of adding a document to a target database according to some embodiments of the present disclosure.

FIG. 3 is a flowchart of an information retrieval method according to some embodiments of the present disclosure.

FIG. 4 is a flowchart of a document retrieval method according to some embodiments of the present disclosure.

FIG. 5 is a schematic structural diagram of a device for establishing a database according to some embodiments of the present disclosure.

FIG. 6 is a schematic structural diagram of an information retrieval device according to some embodiments of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

The terms “first,” “second,” or the like in the specification, claims, and the drawings of the present disclosure are merely used to distinguish similar elements, and are not intended to describe a specified order or a sequence. The involved elements may be interchangeable in any suitable situation, so that the present disclosure can be performed in the order or sequence different from that shown in the figures or described in the specification. In addition, the terms “including,” “comprising,” and variations thereof herein are open, non-limiting terminologies, which are meant to encompass a series of steps of processes and methods, or a series of units of systems, apparatus, or devices listed thereafter and equivalents thereof as well as additional steps of the processes and methods or units of the systems, apparatus, or devices.

Embodiments of the present disclosure provide a method for establishing a database and an information retrieval method. These methods can be applied to the field of information retrieval, specifically in scenarios where large models (LM) are used for information processing. The large model in the embodiment of the present disclosure refers to a deep learning model trained with a large amount of data, which can generate natural language text or understand the meaning of language text. The large model can handle a variety of natural language tasks, such as text classification, question answering, dialogue, etc., and is an important part of the field of artificial intelligence. The method for establishing database method and information retrieval method provided in the embodiments of the present disclosure can reduce interference information in the large model processing process and improve the accuracy of large model processing. For example, the accuracy of information retrieval based on large models can be improved.

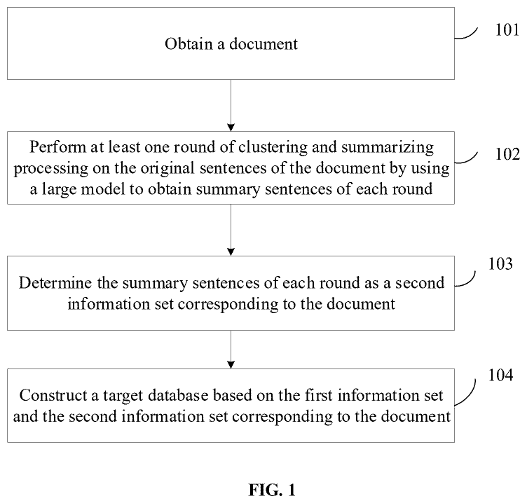

In order to meet users' actual information retrieval needs and improve the accuracy of information processing based on large models, in the embodiment of the present disclosure, a personal database matching the user can be established in the user terminal such that the accuracy of subsequent user-related information processing can be improved based on the information in the database. FIG. 1 is a flowchart of a method for establishing a database according to some embodiments of the present disclosure. The method will be described in detail below.

101, obtaining a document.

102, performing at least one round of clustering and summarizing processing

on the original sentences of the document by using the large model to obtain summary sentences of each round.

103, determining the summary sentences of each round as a second information set corresponding to the document.

104, constructing a target database based on a first information set and the second information set corresponding to the document.

The documents used to build the database may be documents related to the corresponding target user. These documents can be documents that the target user is interested in, or documents that have been downloaded on the terminal device used by the target user. These documents can better reflect the user's interests, and the relevant information of these documents can assist in processing the information generated by the target user in order to obtain more accurate result information that better meets the user's needs. In order to obtain more accurate information, a plurality of documents can be obtained in the process of establishing the database. The more the number of documents, the more document information can be provided to improve the accuracy of subsequent processing.

Large models refer to large language models, which are composed of neural networks with many parameters and are trained on a large amount of unlabeled text using self-supervised learning or semi-supervised learning. Since the large model is trained on a large-scale corpus to learn various grammatical, semantic and contextual rules of natural language, large models can automatically process text information. In the embodiments of the present disclosure, by clustering and summarizing the original sentences of the document through the large models, the purpose of converting large blocks of text into concise and coherent summary information of the corresponding cluster can be achieved, and the main content of the information in the documents and the summary content of the corresponding topics can be obtained.

The original sentence of the document can be a sentence obtained by segmenting the text information of the document based on specific segmentation characters, such as punctuation marks or specific sentence length. After the original sentence is obtained, the original sentence can be clustered and summarized through the large model for at least one round. Clustering and sentence summarization need to be performed in each round of clustering and summarizing processing. The to-be-processed information in each round may be the result information after the previous round of processing. Based on at least one round of clustering and summarizing processing, when the document has more complex subject content, the relevant subject content of the document can be obtained more clearly, thereby reducing the interference information of subsequent applications.

The summary sentence of each round can be determined as the second information set corresponding to the document, and a target database can be constructed based on the first information set and the second information set corresponding to the document. The first information set may include at least one original sentence corresponding to the document. The tag database may include a first information set and a second information set corresponding to a plurality of documents respectively. Each document may have a corresponding first information set and a second information set. In order to distinguish the first information set and the second information set of each document, when generating the first information set and the second information set, the original sentence included in the first information set may be annotated with document identification information of the corresponding document, and the summary sentence included in the second information set may also be annotated marked with the document identification information of the corresponding document. Accordingly, the sources of the documents to which the original sentences and summary sentences belong can be distinguished.

The target database may include a first information set and a second information set corresponding to a plurality of documents respectively. Therefore, the first information set and the second information set corresponding to all documents can be obtained through the target database. Alternatively, the first information set and the second information set corresponding to a specific document can also be obtained through the target database. Accordingly, accurate acquisition of the original sentence information and summary sentence information of the document in the target database can be realized, that is, more detailed information of the document can be obtained, which is convenient for subsequent applications.

In some embodiments, sentence segmentation processing may be performed on the document to obtain at least one original sentence corresponding to the document; the at least one original sentence may be determined as the first information set corresponding to the document. When the text information in the document is segmented, the sentence may be segmented based on the punctuation marks, separators and other information characters in the document to obtain the original sentence. Further, to improve the processing accuracy, the original sentence after removing repeated sentences in the original sentence, or the original sentence of a specific length can be selected to form the first information set.

Correspondingly, in some embodiments, performing at least one round of clustering and summarizing processing on the original sentences of the document through the large model to obtain the summary sentence of each round may include: using an embedding model to extract features from the original sentences of the first round of to-be-processed documents to obtain the feature vector corresponding to each original sentence; clustering the feature vectors to obtain at least one cluster; summarizing each original sentence in each cluster based on the large model to obtain at least one summary sentence corresponding to the first round; using the summary sentence corresponding to the first round as the original sentence to be processed in the second round and performing the second round of clustering and summarizing processing to obtain at least one summary sentence corresponding to the second round; iterating the steps of clustering and summarizing processing until a target stopping condition is reached. The target stopping condition may be that the position of the cluster center of the cluster no longer changes, or the number of executions of the clustering and summarizing processing steps reaches the target number of times. An embedding model is a machine learning model that is widely used in fields such as natural language processing (NLP) and computer vision (CV). The main function of the embedding model is to transform high-dimensional data into a low-dimensional embedding space while retaining the characteristics and semantic information of the original data, thereby improving the efficiency and accuracy of the model. Embedding models can map similar data into similar embedding spaces by learning the correlation between data, allowing the model to better understand and process data. By representing each data point as a vector, the semantic information of the data can be encoded into the vector space. The advantage of doing this is that the properties of the vector space can be utilized. For example, the distance between vectors can represent the similarity of the data.

The process of obtaining the summary sentence may be implemented in an iterative manner, which can capture both high-level and low-level details of the document text. FIG. 2 is a schematic diagram of adding a document to a target database according to some embodiments of the present disclosure. In this process, the embedding model, document clustering, large model (LM language model) processing and other modules are used. First, a document parsing module can be used to segment the documents to be added to the target database to obtain the original sentences of the to-be-stored documents. Then, multiple rounds of clustering and summarizing can be performed on the to-be-stored original sentences. The following takes the first round of clustering processing as an example for explanation. The feature vectors of the original sentences of the current round (e.g., Chunk 1 to Chunk z shown in FIG. 2) are extracted using the embedding model, and the extracted feature vectors are grouped and clustered using the document clustering model, the extracted feature vectors are grouped and clustered through the document clustering model to obtain n clusters, each of which including several original sentences. For example, the clustering algorithm may be the kmeans algorithm, which performs clustering on each feature vector. More specifically, the cluster center can be determined. Subsequently, based on the distance between each eigenvector and each cluster center, the center point corresponding to each eigenvector can be determined, and each center can be used to generate the cluster corresponding to the center for each eigenvector. Then, based on the average value of the feature vector in each cluster, the new cluster center can be determined. This iterative process can be stopped when the position of the cluster center of the cluster no longer changes, or when the number of executions of the clustering and summarizing processing reaches the target number of executions.

Subsequently, the large model can be used to summarize the original sentences in each of the n clusters, and the large model can be used to convert large blocks of text (i.e., the original sentences in the current cluster) into a concise and coherent summary of the selected cluster. For example, in order for the large model to obtain accurate summary sentences, a corresponding summary task branch can be set for the large model, such as generating prompt information that prompts the large model to summarize the sentence. Accordingly, the large model can generate the corresponding summary sentence based on the prompt information. For example, the prompt message for the summary task branch can be “You are a Summarizing Text Portal, write a summary of the following, including as many key details as possible: {context}”. Accordingly, n summary sentences can be obtained, that is, each cluster can obtain a summary sentence, such as Chunk1a to Chunk1n shown in FIG. 2.

The summary sentences Chunk1a to Chunk1n obtained in the first round can be used as the original sentences to be processed in the second round, and then the above operations can be repeated until the cluster center no longer changes. That is, further clustering ends when it becomes infeasible, thereby generating the first information set and the second information set corresponding to the original document, that is, obtaining a structured, multi-layer tree structure. As shown in FIG. 2, the original sentences in the elliptical area and the summary sentences in the gray rectangular area form a multi-layer tree from right to left. The summary sentences obtained through multiple rounds of clustering and summarizing, along with the original sentences and extracted feature values, can be stored in the vector database to obtain the target database for subsequent retrieval. For example, if all documents are related to the user, user-related information can be obtained based on the documents in the target database such that subsequent retrieval can better meet the needs of the user and provide more accurate retrieval information.

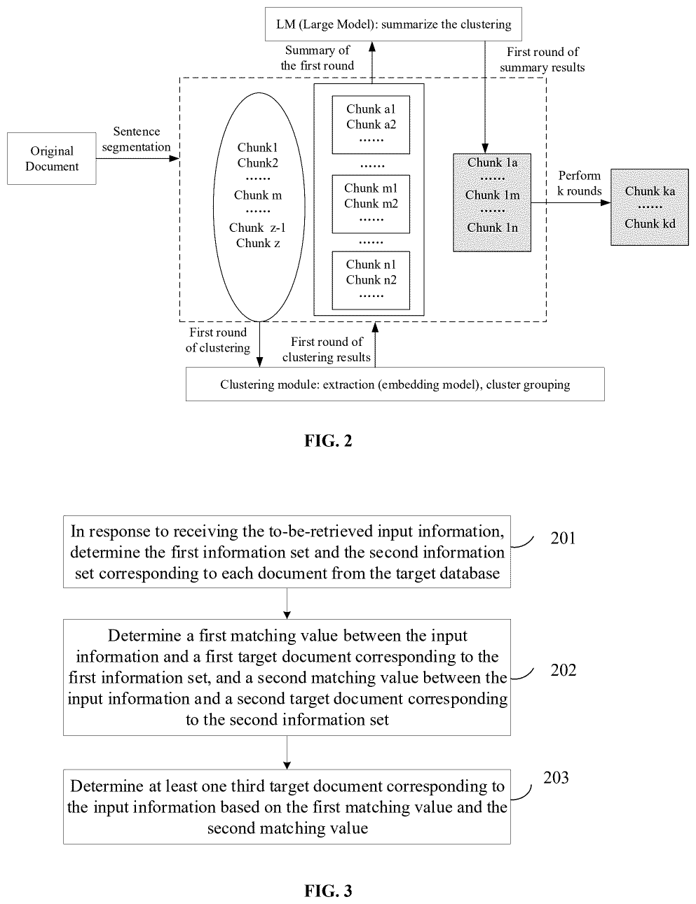

Correspondingly, embodiments of the present disclosure provide an information retrieval method. FIG. 3 is a flowchart of an information retrieval method according to some embodiments of the present disclosure. The method will be described in detail below.

201, in response to receiving the to-be-retrieved input information, determining the first information set and the second information set corresponding to each document from the target database.

202, determining a first matching value between the input information and a first target document corresponding to the first information set, and a second matching value between the input information and a second target document corresponding to the second information set.

203, determining at least one third target document corresponding to the input information based on the first matching value and the second matching value.

In some embodiments, the first information set may include at least one original sentence corresponding to the document, and the second information set may include a summary sentence obtained by at least one round of clustering and summarizing of the original sentence corresponding to the document. The first target document may be the same as or different from the second target document, and the third target document may belong to the first target document or the second target document.

The received to-be-retrieved input information may be the search information input by the target user. If the input information is text information, the text information can be directly used as the to-be-retrieved input information. If the user inputs non-text information such as audio, the information can be converted into text information and used as the to-be-retrieved input information. In some embodiments, determining the first information set and the second information set corresponding to each document from the target database may include obtaining the first information set and the second information set corresponding to all documents in the target database, or determining the first information set and the second information set corresponding to each document in a specific document based on the input information. For example, a specific document may be determined based on the retrieval time of the input information and the time when each document is added to the target database.

Subsequently, based on the relevance between the input information and the original sentence in the first information set, a first target document can be determined, and then a first matching value between the input information and the first target document can be obtained. The first matching value may represent the relevance between the input information determined by the original sentence and the first target document. Further, based on the relevance between the input information and the summary sentence in the second information set, a second target document can be determined, and then a second matching value between the input information and the second target document can be obtained. The second matching value may represent the relevance between the input information determined by the summary sentence and the second target document.

In some embodiments, the second information set may be a sentence obtained by performing at least one round of clustering and summarizing based on the original sentence. Therefore, the second target document determined by the second information set may be the same as or different from the first target document determined by the original sentence. Based on the first matching value between the input information and the first target document and the second matching value between the input information and the second target document, at least one third target document corresponding to the input information can be determined. The third target document may belong to the first target document or the second target document. The first target document and the second document can be sorted based on the first matching value and the second matching value, and the target document that is ranked higher has a higher matching value with the input information, that is, the more relevant it is to the input information. Accordingly, the most relevant at least one first target document and/or second target document can be identified as the third target document. In the embodiments of the present disclosure, at least one third target document that is most relevant to the input information can be determined based on the original sentence and summary sentence of the document, thereby analyzing the information of the document from different information dimension categories. Accordingly, high-level and low-level details of the document can be obtained, making the matched document content more relevant.

In some embodiments, after the third target document is obtained, the third target document may be directly output, or it may be used as auxiliary information for subsequent processing of the large model.

In some embodiments, the information retrieval method may further include using the corresponding at least one third target document as prompt information, and processing the prompt information and input information through the large model to obtain the corresponding target search result information.

The prompt information in the large model is a type of information enhancement data, the purpose of which is to make the large model clear about the tasks to be performed and the output content. The prompt information can be used to reuse the goals and parameters used by the large model in the pre-training stage, and some parameters can be adjusted based on them, thereby saving hardware computing resources and storage resources. Accordingly, the large model is more accurate in actual application scenarios, the cost of model construction is reduced, and the efficiency of establishing the model is improved. In the embodiments of the present disclosure, by determining at least one third target document in the target database, the at least one third target document can be used as prompt information of the large model. Since the documents in the target database can be documents related to the user, such as local documents downloaded by the user, documents that the user is interested in, etc., the large model can be guided to output target search result information that matches the user's input information more closely based on the input information.

The following is a detailed description of the relevant contents of the information retrieval method provided in the embodiments of the present disclosure. In some embodiments, determining the first matching value between the input information and the first target document corresponding to the first information set may include determining a first sub-matching value of each original sentence in the first information set corresponding to each document and the input information; determining the target original sentence based on the first sub-matching value of each original sentence; determining the first matching value between the first target document and the input information based on the first sub-matching value corresponding to the target original sentence input into the same first target document.

In some embodiments, the first sub-matching value of each original sentence in the first information set corresponding to each document and the input information can be determined. That is, the relevance of the input information to all original sentences in each document in the target database can be determined. For example, the first sub-matching value can be determined based on the cosine similarity between the input feature vector corresponding to the input information and the original sentence feature vector corresponding to the original sentence. Subsequently, the original sentences can be sorted based on the first sub-matching values. The higher the ranking, the higher the match between the corresponding original sentence and the input information. The top N original sentences may be selected as the target original sentences. Alternatively, a first sub-matching value threshold may be set, and an original sentence whose first sub-matching value is greater than the first sub-matching value threshold may be determined as the target original sentence. Based on the document identification information corresponding to these target original sentences, these target original sentences can be aggregated into one or more corresponding first target documents.

For example, the first target document D1 includes the target original sentences Chunk 1 to Chunk t. Based on the value of the first sub-matching value corresponding to each target original sentence, the first matching value between the first target document D1 and the input information can be obtained by adding them together. For example, the first sub-matching value between the target original sentence Chunk 1 and the input information is a, and the first sub-matching degree between Chunk 2 and the input information is b . . . the first sub-matching value between the Chunk t and the input information is t, then the first matching value between the first target document D1 and the input information=a+b+. . . +t.

Correspondingly, determining the second matching degree between the input information and the second target document corresponding to the second information set includes: determining a second sub-matching value of each summary sentence in the second information set corresponding to each document and determining the target summary sentence based on the second sub-matching value of each summary sentence; determining the second matching value between the second target document and the input information based on the second sub-matching value corresponding to the target summary sentence belonging to the same second target document.

More specifically, the second sub-matching value between the input information and each summary sentence can be determined based on the similarity between the input feature vector corresponding to the input information and the summary sentence feature vector corresponding to the summary sentence. Then, the summary sentences can be sorted based on the second sub-matching values, and the summary sentences with the highest ranking can be determined as the target summary sentences. The document that includes the target summary sentence may be the second target document. Then, based on the document identification information corresponding to the target summary sentence, the target summary sentence can be aggregated. The second matching value between the second target document and the input information can be determined based on the second sub-matching value corresponding o the target summary sentence belonging to the same second target document. For example, the second matching value corresponding to the second target document may be the sum of the second sub-matching values of each target summary sentence included in the second target document.

Correspondingly, in some embodiments, the process of determining at least one third target document corresponding to the input information based on the first matching value and the second matching value may include: determining the first document set based on the first matching value between each first target document and the input information; determining the second document set based on the second matching value between each second target document and the input information; determining at least one third target document corresponding to the input information based on the first document set and the second document set.

More specifically, the first target documents may be sorted based on the first matching value between the first target documents and the input information, and at least one first target document with a top ranking may be obtained as the first document set. Similarly, the second target documents may be sorted based on the second matching value between the second target document and the input information, and at least one second target document with a top ranking may be obtained as the second document set. Then, the target documents repeated in the first document set and the second document set can be used as the third target document; or corresponding target documents can be selected from the first document set and the second document set respectively based on a preset number of third target documents. In some embodiments, the target documents selected in the first document set and the second document set may be the top ranked documents in the corresponding document set, that is, the documents with the highest matching value with the input information.

In some embodiments, when determining the first matching value between the first target document and the input information based on the first sub-matching value corresponding to the target original sentence belonging to the same first target document, the values of the first matching values between the first target documents and the input information may all be relatively low. That is, the correlation between each first target document and the input information is low. Or the number of target original sentences belonging to the same first target document is small, which can also indicate that the first target document has a low correlation with the input information. In this case, based on the first sub-matching value between the target original sentence and the input information, the target original sentence most relevant to the input information can be determined as the prompt information for retrieval of the large model.

Similarly, when determining the second matching value between the second target document and the input information based on the second sub-matching value corresponding to the target summary sentence belonging to the same second target document, the values of the second matching values between the second target documents and the input information may all be relatively low. That is, the correlation between each second target document and the input information is low. Or the number of target summary sentences belonging to the same second target document is small, which can also indicate that the second target document has a low relevance to the input information. In this case, based on the second sub-matching value between the target summary sentence and the input information, the target summary sentence most relevant to the input information can be determined as the prompt information for retrieval of the large model.

Accordingly, when the document as a whole is poorly related to the input information, the prompt information of the large model can be determined through the target original sentence and/or the target summary sentence. This can avoid introducing too much interference information from irrelevant documents and improve the accuracy of subsequent processing of the large models.

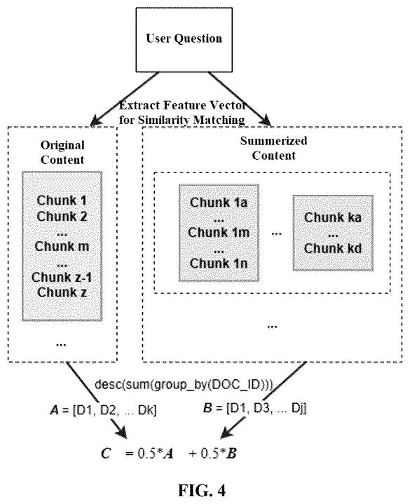

The following uses the application scenario of document retrieval as an example to illustrate the information retrieval method provided in the embodiments of the present disclosure. FIG. 4 is a flowchart of a document retrieval method according to some embodiments of the present disclosure.

Refer to FIG. 4, first, the user's question information is obtained, and the question information is used as the to-be-retrieved input information. Next, a pre-established target database is obtained. The pre-established target database includes multiple documents.

The first information set corresponding to each document, that is, an original sentence corresponding to each document can be obtained. In FIG. 4, {Chunk1, Chunk2, . . . , Chunk m, . . . , Chunk z-1, Chunk z} represent the original sentences. Correspondingly, the second information set corresponding to each document, that is, the summary sentence after k rounds of clustering and summarizing corresponding to each document, can be obtained. In FIG. 4, the summary sentences obtained by the first round of clustering and summarizing is expressed as {Chunk1a, . . . , Chunk 1m, . . . , Chunk 1n}, and the summary sentences obtained by the kth round of clustering summary is expressed as {Chunk ka, . . . , Chunk kd}.

Take the original sentence processing as an example. The original sentences can be filtered based on the similarity between the original sentences and the input information of the user's question (e.g., the similarity can be calculated using an embedding model) to obtain the topN original sentences as the target original sentences, and obtain the similarity score between each target original sentence and the input information. Document aggregation can be performed on each target original sentence based on the document information to which the target original sentence belongs (e.g., DOC_ID representing the document representation). If the target original sentence Chunk 1˜Chunk t in document D1 meets the filtering condition, the scores of Chunk 1˜Chunk t can be summed to get scoreA1, which is used as the score of document D1. The recalled document list can be sorted in descending order of score to get the top K document set A. When determining the target document based on the summary sentence obtained by round k of summarization, the top L document set B can be obtained in a similar way to the original sentence processing. As shown in FIG. 4, document set A includes documents D1, D2, . . . , Dk; document set B includes documents D1, D3, . . . , Dj. Document sets A and B can be merged to obtain the final result document set C. Both branches can use the same document recall weight, for example C=0.5*A +0.5*B. The use of this mixed recall method can reduce the impact of interference documents on the results (ranking reduction), and has an enhancement effect on documents with more content matches, that is, the ranking of documents with more content matches is increased.

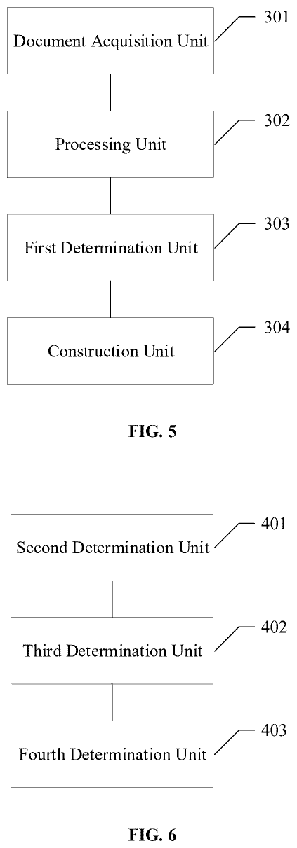

Embodiments of the present disclosure provide a device for establishing a database. FIG. 5 is a schematic structural diagram of a device for establishing a database according to some embodiments of the present disclosure. As shown in FIG. 5, the device for establishing a database includes a document acquisition unit 301, a processing unit 302, a first determination unit 303, and a construction unit 304.

In some embodiments, the document acquisition unit 301 may be configured to obtain a document.

In some embodiments, the processing unit 302 may be configured to perform at least one round of clustering and summarizing processing on the original sentences of the document through the large model to obtain summary sentences of each round.

In some embodiments, the first determination unit 303 may be configured to determine the summary sentence of each round as a second information set corresponding to the document.

In some embodiments, the construction unit 304 may be configured to construct a target database based on the first information set and the second information set corresponding to the document.

In some embodiments, the first information set may include at least one original sentence corresponding to the document, and the target database may include a first information set and a second information set corresponding to a plurality of documents respectively.

In some embodiments, the device for establishing a database may also include a segmentation processing unit. The segmentation processing unit may be configured to perform sentence segmentation processing on the document to obtain at least one original sentence corresponding to the document; and determine at least one original sentence as the first information set corresponding to the document.

In some embodiments, the processing unit may include an extraction subunit, a clustering subunit, a summarizing subunit, an execution subunit, and an iterative processing subunit. The extraction subunit may be configured to extract features from the original sentences of the to-be-processed document in the first round using the embedding model to obtain a feature vector corresponding to each original sentence. The clustering subunit may be configured to cluster the feature vector to obtain at least one cluster. The summarizing subunit may be configured to summarize each original sentence in each of the clusters based on the large model to obtain at least one summary sentence corresponding to the first round. The execution subunit may be configured to use the summary sentence corresponding to the first round as the to-be-processed original sentence in the second round, perform the second round of clustering and summarizing processing, and obtain at least one summary sentence corresponding to the second round. The iterative processing subunit may be configured to iteratively execute the clustering and summarizing processing steps until the target stopping condition is reached. The target stop condition may include that the position of the cluster center of the cluster no longer changes, or the number of execution times of the step of executing the clustering and summarizing processing reaches the target number of times.

Embodiments of the present disclosure provide an information retrieval device. FIG. 6 is a schematic structural diagram of an information retrieval device according to some embodiments of the present disclosure. As shown in FIG. 6, the information retrieval device includes a second determination unit 401, a third determination unit 402 and a fourth determination unit 403.

In some embodiments, the second determination unit 401 may be configured to determine the first information set and the second information set corresponding to each document from the target database in response to receiving the to-be-retrieved input information. The first information set may include at least one original sentence corresponding to the document, and the second information set may include a summary sentence obtained by at least one round of clustering and summarizing of the original sentence corresponding to the document.

In some embodiments, the third determination unit 402 may be configured to determine a first matching value between the input information and the first target document corresponding to the first information set, and a second matching value between the input information and the second target document corresponding to the second information set.

In some embodiments, the fourth determination unit 403 may be configured to determine at least one third target document corresponding to the input information based on the first matching value and the second matching value.

In some embodiments, the first target document may be the same as or different from the second target document, and the third target document may belong to the first target document or the second target document.

In some embodiments, the information retrieval device may also include a large model processing unit. The large model processing unit may be configured to use the corresponding at least one third target document as prompt information, process the prompt information and the input information through the large model, and obtain corresponding the target search result information.

In some embodiments, the third determination unit may include a first sub-determination unit. The first sub-determination unit may be configured to determine a first sub-matching value of each original sentence in the first information set corresponding to each document and the input information; determine the target original sentence based on the first sub-matching value of each original sentence; determine the first matching degree between the first target document and the input information based on the first sub-matching value corresponding to the target original sentence belonging to the same first target document.

In some embodiments, the third determination unit may include a second sub-determination unit. The second sub-determination unit may be configured to determine a second sub-matching value between the input information and each summary sentence in the second information set corresponding to each document; determine a target summary sentence based on the second sub-matching value of each summary sentence; determine the second matching value between the second target document and the input information based on the second sub-matching value corresponding to the target summary sentence belonging to the same second target document.

In some embodiments, the fourth determination unit may be configured to determine the first document set based on the first matching value between each first target document and the input information; determine the second document set based on the second matching value between each second target document and the input information; determine at least one third target document corresponding to the input information based on the first document set and the second document set.

It should be noted that for the specific implementation of each unit and sub-

unit in this embodiment, reference can be made to the corresponding content in the foregoing embodiments, which will not be described in detail here.

Embodiments of the present disclosure provides a readable storage medium having a computer program stored thereon. When the computer program is executed by a processor, the method for establishing a database and/or information retrieval method described in any one of the foregoing embodiments can be implemented.

Embodiments of the present disclosure provides an electronic device. The electronic device may include a memory and a processor. The memory may be used to store applications and data generated by the operation of the applications, and the processor may be configured to execute the applications to implement the method for establishing a database and/or information retrieval method as described in any one of the foregoing embodiments.

It should be noted that for the details of the specific implementation of the processor in this embodiment, reference can be made to the corresponding content in the foregoing embodiments, which will not be described in detail here.

The embodiments provided in the present disclosure are described in a progressive manner. Each embodiment focuses on the differences from other embodiments, and the same or similar parts among these embodiments may be referred to each other. For the devices disclosed in the embodiments, the description may be relatively simple because of the corresponding relation between the devices and the disclosed methods. The details of the disclosed devices may be referred to the corresponding content in the description of the methods.

Those skilled in the art may further realize that the units and algorithm steps of the examples described with reference to the embodiments disclosed herein can be implemented by electronic hardware, computer software, or a combination of the two. To clearly illustrate the interchangeability of hardware and software, the components and steps of various examples have been generally described in terms of their functionality. Whether these functions are implemented by hardware or software depends on the specific application and the design constraints of the technical solutions. A person skilled in the art may use different methods to implement the described functions for each particular application. However, such implementation should not be considered as beyond the scope of the present disclosure.

The steps of the method or algorithm described in the embodiments disclosed herein may be implemented directly by hardware, a processor-executable software module, or a combination of the two. The software module may be located in random access memories (RAMs), internal memories, read-only memories (ROMs), electrically programmable ROMs, electrically erasable programmable ROM, registers, hard disks, removable disks, CD-ROMs, or other storage media that are well known in the field.

The description of the disclosed embodiments provided above ensures that those skilled in the art can realize or use the present disclosure. Various modifications to the embodiments are readily apparent to those skilled in the art. The general principles herein may be implemented in other embodiments without departing from the spirit or scope of the disclosure. Therefore, the present disclosure should not be limited to these embodiments described herein, but rather should be in accordance with the broadest scope consistent with the principles and the novel features disclosed herein.

What is claimed is:

1. A method for establishing a database comprising:
obtaining a document;
performing clustering and summarizing processing on original sentences of the document for at least one round by using a large model to obtain summary sentences for each round;
determining the summary sentence of each round as a second information set corresponding to the document; and
constructing a target database based on a first information set and the second information set corresponding to the document, wherein the first information set includes at least one original sentence corresponding to the document, and the target database includes the first information set and the second information set corresponding to a plurality of documents respectively.

2. The method of claim 1 further comprising:
performing sentence segmentation processing on the document to obtain at least one original sentence corresponding to the document; and
determining at least one of the original sentences as the first information set corresponding to the document.

3. The method of claim 1, wherein, performing clustering and summarizing processing on the original sentences of the document for at least one round by using the large model to obtain summary sentences for each round includes:
using an embedding model to extract features from the original sentences of the to-be-processed document in the first round to obtain a feature vector corresponding to each original sentence;
clustering the feature vectors to obtain at least one cluster;
summarizing each original sentence in each cluster based on the large model to obtain at least one summary sentence corresponding to the first round;
using the summary sentence corresponding to the first round as the to-be-processed original sentence in a second round, and performing the second round of clustering and summarizing processing to obtain at least one summary sentence corresponding to the second round; and
iteratively executing the clustering and summarizing processing steps until a target stopping condition is reached, the target stopping condition including that a position of the cluster center of the cluster no longer changes, or a number of executions of the clustering and summarizing processing steps reaches a target number of executions.

4. An information retrieval method comprising:
in response to receiving to-be-retrieved input information, determining a first information set and a second information set corresponding to each document from a target database, the first information set including one original sentence corresponding to the document, the second information set including a summary sentence obtained by at least one round of clustering summarizing processing on the original sentence corresponding to the document;
determining a first matching value between the input information and a first target document corresponding to the first information set, and a second matching value between the input information and a second target document corresponding to the second information set; and
determining at least one third target document corresponding to the input information based on the first matching value and the second matching value, wherein the first target document is the same as or different from the second target document, and the third target document belongs to the first target document or the second target document.

5. The information retrieval method of claim 4 further comprising:
using the corresponding at least one third target document as prompt information, processing the prompt information and the input information through the large model to obtain corresponding target search result information.

6. The information retrieval method of claim 4, wherein determining the first matching value between the input information and the first target document corresponding to the first information set includes:
determining a first sub-matching value of each original sentence in the first information set corresponding to each document and the input information; and
determining a target original sentence based on the first sub-matching value of each original sentence; and
determining the first matching value between the first target document and the input information based on the first sub-matching value corresponding to the target original sentence belonging to the same first target document.

7. The information retrieval method of claim 4, wherein determining the second matching value of the second target document corresponding to the input information and the second information set includes:
determining a second sub-matching value of each summary sentence in the second information set corresponding to each document and the input information;
determining a target summary sentence based on the second sub-matching value of each summary sentence; and
determining the second matching value between the second target document and the input information based on the second sub-matching value corresponding to the target summary sentence belonging to the same second target document.

8. The information retrieval method of claim 6, wherein determining at least one third target document corresponding to the input information based on the first matching value and the second matching value includes:
determining a first document set based on the first matching value between each first target document and the input information;
determining a second document set based on the second matching value between each second target document and the input information; and
determining at least one third target document corresponding to the input information based on the first document set and the second document set.

9. A device for establishing a database comprising one or more processors and computer program instructions stored in computer readable storage medium, when executed by the one or more processors, the computer instructions implementing a method for establishing the database, the method comprising:
obtaining a document;
performing clustering and summarizing processing on original sentences of the document for at least one round by using a large model to obtain summary sentences for each round;
determining the summary sentence of each round as a second information set corresponding to the document; and
constructing a target database based on a first information set and the second information set corresponding to the document, wherein the first information set includes at least one original sentence corresponding to the document, and the target database includes the first information set and the second information set corresponding to a plurality of documents respectively.

10. The device of claim 9, wherein the method further comprises:
performing sentence segmentation processing on the document to obtain at least one original sentence corresponding to the document; and
determining at least one of the original sentences as the first information set corresponding to the document.

11. The device of claim 9, wherein, performing clustering and summarizing processing on the original sentences of the document for at least one round by using the large model to obtain summary sentences for each round includes:
using an embedding model to extract features from the original sentences of the to-be-processed document in the first round to obtain a feature vector corresponding to each original sentence;
clustering the feature vectors to obtain at least one cluster;
summarizing each original sentence in each cluster based on the large model to obtain at least one summary sentence corresponding to the first round;
using the summary sentence corresponding to the first round as the to-be-processed original sentence in a second round, and performing the second round of clustering and summarizing processing to obtain at least one summary sentence corresponding to the second round; and
iteratively executing the clustering and summarizing processing steps until a target stopping condition is reached, the target stopping condition including that a position of the cluster center of the cluster no longer changes, or a number of executions of the clustering and summarizing processing steps reaches a target number of executions.

12. A device for establishing a database comprising one or more processors and computer program instructions stored in computer readable storage medium, when executed by the one or more processors, the computer instructions implementing a method for retrieving information, the method comprising:
in response to receiving to-be-retrieved input information, determining a first information set and a second information set corresponding to each document from a target database, the first information set including one original sentence corresponding to the document, the second information set including a summary sentence obtained by at least one round of clustering summarizing processing on the original sentence corresponding to the document;
determining a first matching value between the input information and a first target document corresponding to the first information set, and a second matching value between the input information and a second target document corresponding to the second information set; and
determining at least one third target document corresponding to the input information based on the first matching value and the second matching value, wherein the first target document is the same as or different from the second target document, and the third target document belongs to the first target document or the second target document.

13. The device of claim 12, wherein the method further comprises:
using the corresponding at least one third target document as prompt information, processing the prompt information and the input information through the large model to obtain corresponding target search result information.

14. The device of claim 12, wherein, determining the first matching value between the input information and the first target document corresponding to the first information set includes:
determining a first sub-matching value of each original sentence in the first information set corresponding to each document and the input information; and
determining a target original sentence based on the first sub-matching value of each original sentence; and
determining the first matching value between the first target document and the input information based on the first sub-matching value corresponding to the target original sentence belonging to the same first target document.

15. The device of claim 12, wherein, determining the second matching value of the second target document corresponding to the input information and the second information set includes:
determining a second sub-matching value of each summary sentence in the second information set corresponding to each document and the input information;
determining a target summary sentence based on the second sub-matching value of each summary sentence; and
determining the second matching value between the second target document and the input information based on the second sub-matching value corresponding to the target summary sentence belonging to the same second target document.

16. The device of claim 14, wherein, determining at least one third target document corresponding to the input information based on the first matching value and the second matching value includes:
determining a first document set based on the first matching value between each first target document and the input information;
determining a second document set based on the second matching value between each second target document and the input information; and
determining at least one third target document corresponding to the input information based on the first document set and the second document set.
